(19) United States
(12) Patent Application Publication
(10) Pub. No.: US 2015/0241814 A1
(43) Pub. Date: Aug. 27, 2015

(54) STORAGE, TONER PASSAGE, AND IMAGE FORMING APPARATUS

(71) Applicant: Sharp Kabushiki Kaisha, Osaka (JP)

(72) Inventors: Hiroshi TANISAWA, Osaka-shi (JP); Hiroshi SUGIMURA, Osaka-shi (JP); Masahiro SAKAI, Osaka-shi (JP)

(21) Appl. No.: 14/614,478

(22) Filed: Feb. 5, 2015

(30) Foreign Application Priority Data
Feb. 27, 2014 (JP) 2014-036270

(51) Int. Cl. G03G 15/08; G03G 21/00

(52) U.S. Cl. CPC G03G 15/0865; G03G 15/095

(57) ABSTRACT

Waste toner scraped off a surface of a photoreceptor drum is transported by a toner conveyor screw of a cleaner and sent into a process pipe. The process pipe includes an end that does not have a screw, and a moth-eye structure is provided on an inner wall surface of the end by applying a moth-eye sheet. Thus, the waste toner is prevented from remaining at the end of the process pipe.

### BACKGROUND OF THE INVENTION

1. Field of the Invention

The present invention relates to a storage, a toner passage, and an image forming apparatus and, more specifically, relates to a storage such as a toner cartridge and a housing of a developer configured to store toner and developer, a toner passage configured to carry the toner before or after a developing step, and an image forming apparatus including the storage and the toner passage.

2. Description of the Related Art

JP 06-308867 A discloses an example of a waste toner retrieving device for retrieving toner subjected to a developing step into a toner retrieving bottle.

In the waste toner retrieving device in JP 06-308867 A, a region with an array of rectangular dents is formed on an inner wall surface of a post-cleaning toner passage, wherein the dimension of the rectangular dent is slightly smaller than the particle size of waste toner that has been coagulated into a large mass.

The technology disclosed in JP 06-308867 A attempts to prevent waste toner from sticking to the post-cleaning toner passage by reducing area where the waste toner comes into contact with the inner wall surface by means of the rectangular dents; however, this cannot be achieved because, a conveyor screw would grind the waste toner into a smaller size than the dent, such that the toner can still stick to the inner wall surface.

On the other hand, recently, for protecting the environment, efficient use of toner is desired, including minimizing the amount of toner remaining in a toner cartridge or a toner passage and disposed of. To this end, a variety of proposals have been made, for example, increasing flowability of toner itself and rocking a toner passage. However, the former has another problem of affecting the electrostatic property of toner and degrading the image quality, or the latter has further another problem of requiring complex functions that tend to cause a failure, and the like.

### SUMMARY OF THE INVENTION

Accordingly, preferred embodiments of the present invention provide a novel storage, toner passage, and image forming apparatus.

Preferred embodiments of the present invention also provide a storage, toner passage, and image forming apparatus, enabling efficient use of toner by preventing toner from sticking.

A preferred embodiment of the present invention is a storage configured to store toner or developer, including a moth-eye structure provided on an inner wall surface thereof.

The moth-eye structure located on the inner wall surface of the storage is configured to prevent or inhibit the toner or the developer from sticking to the inner wall surface, thus significantly reducing or minimizing the amount of the toner or the developer remaining in the storage, and enabling efficient use of the toner or the developer.

Preferably the storage includes a moth-eye sheet defining the moth-eye structure.

The moth-eye sheet preferably has one principal plane on which the moth-eye structure is provided and the other principal plane, and the other principal plane is applied to the inner wall surface by, for example, bonding. Thus, the moth-eye structure is readily provided on the inner wall surface of the storage.

Another preferred embodiment of the present invention is a toner passage through which toner is carried or passes, including a moth-eye structure provided on an inner wall surface thereof.

The moth-eye structure provided on the inner wall surface of the toner passage prevents or inhibits the toner or the developer from sticking to the inner wall surface, and thus the toner or the developer is prevented from remaining in the toner passage, and the toner or the developer is used efficiently.

The toner passage preferably includes a moth-eye sheet defining the moth-eye structure.

The moth-eye sheet preferably includes one principal plane on which the moth-eye structure is provided and the other principal plane, and the other principal plane is applied to the inner wall surface by, for example, bonding. Thus, the moth-eye structure is capable of being readily provided on the inner wall surface of the toner passage.

A further preferred embodiment of the present invention is an image forming apparatus including the storage according to one of the preferred embodiments of the present invention described herein.

Thus, an image forming apparatus enabling efficient use of toner or developer is provided.

An additional preferred embodiment of the present invention is an image forming apparatus including the toner passage according to one of the preferred embodiments of the present invention described herein.

Thus, an image forming apparatus enabling efficient use of toner or developer is provided.

Yet another preferred embodiment of the present invention is an image forming apparatus including a cleaner configured to convey waste toner removed from a photoreceptor drum by a conveyor screw, a process pipe configured to convey the waste toner transported from the cleaner to a waste toner box, and a moth-eye structure provided on an inner wall surface of the process pipe.

The moth-eye structure provided on the inner wall surface of the process pipe prevents or inhibits the waste toner from sticking to the process pipe inner wall surface, and thus the waste toner is prevented from remaining in the process pipe.

The image forming apparatus preferably includes a toner carrying pipe configured to carry the waste toner from the waste toner box to a toner retrieving box, and a moth-eye structure provided on an inner wall surface of the toner carrying pipe.

The moth-eye structure provided on the inner wall surface of the toner carrying pipe prevents or inhibits the waste toner from sticking to the toner carrying pipe inner wall surface, and thus the toner carrying pipe efficiently carries the waste toner to the toner retrieving box.

Another preferred embodiment of the present invention is an image forming apparatus including a developing roller configured to develop a latent image carried on a photoreceptor drum with developer, a housing configured to contain the developer and supplying the developer to the developing roller, a toner cartridge configured to store toner, a relay pipe configured to send the toner from the toner cartridge to the housing, and a moth-eye structure provided on an inner wall surface of the relay pipe.

The moth-eye structure located on the inner wall surface of the relay pipe prevents or inhibits the toner from sticking to the toner cartridge inner wall surface, and thus the toner is smoothly supplied from the toner cartridge to the developing housing.

The image forming apparatus preferably further includes a moth-eye structure provided on an inner wall surface of the housing.

The moth-eye structure provided on the inner wall surface prevents or inhibits the developer from sticking to the housing inner wall surface, and thus the developer is prevented from remaining in the housing, enabling efficient use of the developer.

The image forming apparatus preferably further includes a moth-eye structure provided on an inner wall surface of the toner cartridge.

The moth-eye structure located on the inner wall surface prevents or inhibits the toner from sticking to the toner cartridge inner wall surface, and thus the toner is prevented from remaining in the toner cartridge, enabling efficient use of the toner.

The moth-eye structure preferably includes continuous minute protrusions with minute pitches in a planar configuration

The moth-eye structure is configured to prevent or inhibit the toner or the developer from sticking to the inner wall surface.

The minute pitch preferably is preferably about 50 nm to about 400 nm, or about 50 nm to about 300 nm, for example.

The effect of preventing or inhibiting the toner or the developer from sticking to the inner wall surface is achieved satisfactorily.

In accordance with various preferred embodiments of the present invention, toner or developer is prevented or inhibited from sticking to an inner wall surface, and thus the toner or the developer is used efficiently.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagrammatic view showing an inner structure of an image forming apparatus to which examples of preferred embodiments of the present invention may be applied.

FIG. 2 is a diagrammatic view showing a portion of a processor according to Example 1 of the present invention in the image forming apparatus shown in FIG. 1.

FIG. 3 is a diagrammatic view schematically showing a moth-eye structure provided on an inner surface of a toner carrying pipe in Example 1.

FIG. 4 is a diagrammatic view showing a function of preventing toner from sticking by a moth-eye structure.

FIGS. 5A to 5D are diagrammatic views showing an example of a method for providing a moth-eye structure on the inner surface of the toner carrying pipe shown in FIG. 3, wherein FIG. 5A shows a moth-eye sheet, FIG. 5B shows a state in which the moth-eye sheet is held on a shaft having air pores, FIG. 5C shows a state in which the shaft is moved and inserted into a system carrying pipe by a positioning member, and FIG. 5D shows a state in which the shaft is freed from air suction and the moth-eye sheet is left inside the toner carrying pipe.

FIG. 6 is a schematic exploded view showing an example of toner cartridges and developing devices according to Examples 2 to 4 of the present invention in the image forming apparatus shown in FIG. 1.

FIG. 7 is a diagrammatic view showing an example of a waste toner retrieving device according to Example 5 of the present invention in the image forming apparatus shown in FIG. 1.

### DETAILED DESCRIPTION OF THE PREFERRED EMBODIMENTS

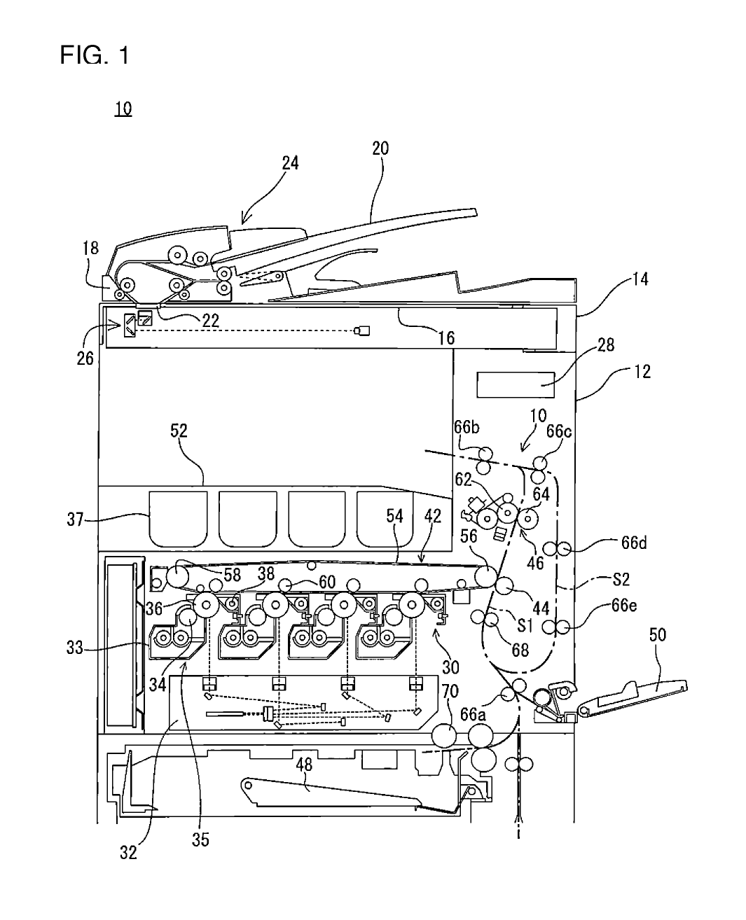

An example of an image forming apparatus to which examples of preferred embodiments of the present invention are applicable will be described with reference to FIG. 1 to the extent necessary for understanding of preferred embodiments of the present invention. However, it is noted that, although a multifunction peripheral (MFP) 10 including functions of copy, printer, scanner, and facsimile, and the like is shown in FIG. 1, the present invention is applicable to any image forming apparatus including one or more of the above functions.

As shown in FIG. 1, the multifunction peripheral 10 includes a multifunction peripheral body 12 and an image reading device 14 disposed in an upper portion thereof. The image reading device 14 includes a document platen 16 made of a transparent material. At an upper portion of the document platen 16, a platen cover 18 is attached in an openable and closable manner via a hinge or the like. The platen cover 18 is provided with an auto document feeder (ADF) 24, which automatically feeds sheets of document placed on a document tray 20 to an image reading position 22 one by one.

At the front side of the document platen 16 (the near side in FIG. 1), an operation interface (not shown) configured to receive user input operation, such as a touch panel and operation buttons are provided.

In addition, the image reading device 14 is provided with an image reading section 26 including a light source, multiple mirrors, an image-forming lens, a line sensor, and the like. The image reading section 26 has the light source illuminate the document surface, which in turn reflects light, which is then guided to the image-forming lens by the multiple mirrors. Then, via the image-forming lens, the reflected light is used to form an image by a light receiving element of the line sensor. In the line sensor, the luminance and/or chromaticity of the image formed by the light receiving element using the reflected light are detected, and image data based on an image on the document surface is generated. Non-limiting examples of the line sensor that is used include charge-coupled devices (CCDs), contact image sensors (CISs), and the like.

Inside the multifunction peripheral body 12, a controller and an image generator 30 are provided. The controller 28 preferably includes a CPU, a memory, and the like to transmit a control signal to each element of the multifunction peripheral 10 in accordance with input operation on the operation interface such as a touch panel, and cause the multifunction peripheral 10 to execute various kinds of operation.

The image generator 30 includes an exposer 32, a developing roller 34, a photoreceptor drum 36, a cleaner 38, a charger 40, an intermediate transfer belt 42, a transfer roller (secondary transfer roller) 44, a fixer 46, and the like to form an image on a sheet of paper (recording paper) carried from a paper feeding cassette 48 or a manual paper feeding cassette 50, and discharge the sheet of paper on which the image has been formed to an exit tray 52. Image data used to form an image on a sheet of paper includes image data read by the image reading section 26 and image data transmitted from an external computer.

It is noted that the image data treated in the multifunction peripheral 10 preferably is image data corresponding to a color image of four colors including black (K), cyan (C), magenta (M), and yellow (Y). Thus, four sets of the developing roller 34, the photoreceptor drum 36, the cleaner 38, and the charger 40 are provided in order to form four types of latent images corresponding to the respective colors, and make four image stations. In addition, the photoreceptor drum 36, the cleaner 38, and the charger 40 preferably are unitized to define a processor. Hence, the image generator 30 is provided with four processors 35 each including the photoreceptor drum 36, the cleaner 38, the charger 40, and the like. Each processor is individually detachable from the front side of the multifunction peripheral 10.

The photoreceptor drum 36 is an image carrier including a photorecepting layer provided on a surface of a conductive cylindrical base, and the charger 40 is a charging member configured to control the surface of the photoreceptor drum 36 at a predetermined potential (e.g., −600 V). For example, a roller charger (roller charging device) 40 is used. In addition, the exposer 32 is a laser scanner including a laser emitter, a reflection mirror, and the like, and illuminates the charged surface of the photoreceptor drum 36 to form an electrostatic latent image corresponding to the image data on the surface of the photoreceptor drum 36. The developing roller 34 is a developing roller that develops the electrostatic latent image formed on the surface of the photoreceptor drum 36 with toner of four colors (YMCK). In addition, the cleaner 38 removes toner having remained on the surface of the photoreceptor drum 36 after developing and image transfer via a cleaning blade (not shown), and carries the removed toner to a waste toner box (not shown in FIG. 1).

In addition, each developing roller 34 is held in the housing 33, and developer of a corresponding color is stored in the housing 33. The developer is supplied to the developing roller 34 while being stirred by a stirring member, and sticks onto the photoreceptor drum 36. Each housing 33 is provided with the corresponding toner cartridge 37 from which toner of a corresponding color toner is supplied to the housing 33 via a relay pipe (to be described later) not shown in FIG. 1.

The intermediate transfer belt 42 includes an intermediate transfer belt 54, a driving roller 56, a driven roller 58, four intermediate transfer rollers 60, and the like, and disposed at an upper portion of the photoreceptor drum 36. The intermediate transfer belt 54 is configured to come into contact with each photoreceptor drum 36, and the toner images of the respective colors formed on the respective photoreceptor drums 36 are transferred onto the intermediate transfer belt 54 sequentially on top of one another by using the intermediate transfer rollers 60, such that a multi-color toner image is formed on the intermediate transfer belt 54. In addition, a transfer roller 44 is disposed near the driving roller 56, and a sheet of paper passes through a nip area between the intermediate transfer belt 54 and the transfer roller 44 such that the toner image formed on the intermediate transfer belt 54 is transferred onto the sheet of paper.

The fixer 46 includes a heat roller 62 and a pressure roller 64, and is disposed at an upper portion of the transfer roller 44. The heat roller 62 is configured to obtain a predetermined fixing temperature, and the sheet of paper passes through a nip area between the heat roller 62 and the pressure roller 64, such that the toner image transferred onto the sheet of paper is melted and pressed to be heat-fixed to the sheet of paper.

In such a multifunction peripheral body 12, a first paper conveyance passage S1 is provided to send a sheet of paper placed in the paper feeding cassette 48 or the manual paper feeding cassette 50 to the exit tray 52 via a paper-stop roller 68, the transfer roller 44, and the fixer 46. In addition, a second paper conveyance passage S2 is provided and configured to, in double-sided printing on a sheet of paper, return a sheet of paper having passed through the fixer 46 following single-sided printing to the first paper conveyance passage S1 upstream of the paper-carrying direction of the transfer roller 44. The first paper conveyance passage S1 and the second paper conveyance passage S2 are appropriately provided with multiple conveyance rollers 66 to convey a sheet of paper.

In single-sided printing in the multifunction peripheral body 12, sheets of paper placed on the paper feeding cassette 48 or the manual paper feeding cassette 50 are guided one by one to the first paper conveyance passage S1 by a pick-up roller 70, and carried to the paper-stop roller 68 by a conveyance roller 66. Then, at the timing when a leading end of a sheet of paper is aligned with a leading end of image information on the intermediate transfer belt 54, the paper-stop roller 68 conveys the sheet of paper to the transfer roller 44 and the toner image is transferred onto the sheet of paper. Subsequently, the sheet of paper passes through the fixer 46 such that unfixed toner on the sheet of paper is melted and firmly fixed by heat, and the sheet of paper is discharged on the exit tray 52 via the conveyance roller (exit roller) 66.

On the other hand, in double-sided printing, when a rear end of the sheet of paper having passed through the fixer 46 following the single-sided printing reaches the exit roller 66 near the exit tray 52, the exit roller 66 rotates backward such that the sheet of paper travels in the opposite direction to be guided to the second paper conveyance passage S2. The sheet of paper guided to the second paper conveyance passage S2 is conveyed by the conveyance roller 66 to the second paper conveyance passage S2, and guided to the first paper conveyance passage S1 upstream of the paper-carrying direction of the paper-stop roller 68. At this point, the sheet of paper is turned upside down, and thus the sheet of paper subsequently passes through the transfer roller 44 and the fixer 46 such that the other side of the sheet of paper is printed.

### Example 1

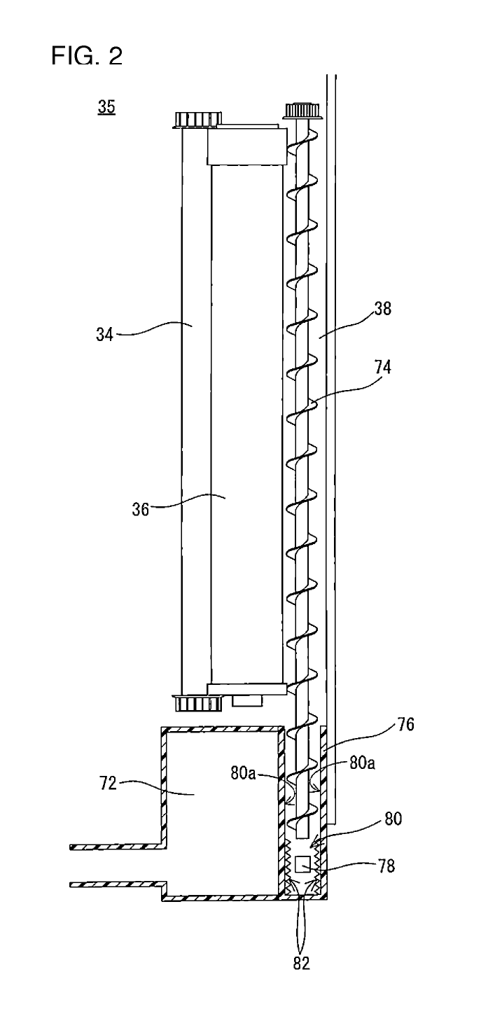

Example 1 according to preferred embodiments of the present invention is applied to a cleaner 38 included in a processor 35 shown in FIG. 2. As described above, the processor 35 includes for each color a developing roller 34, a photoreceptor drum 36, the cleaner 38, and the like. The cleaner 38 sends toner (waste toner), which has remained on the surface of the photoreceptor drum 36 after developing and transfer, and has been removed by, for example, a cleaning roller (not shown) from the surface of the photoreceptor drum 36, into a waste toner box 72 provided inside a multifunction peripheral body 12 in the near side of the photoreceptor drum 36 or an intermediate transfer roller 60.

As clearly shown in FIG. 2, the cleaner 38 includes a toner conveyor screw 74, which is driven at one end side thereof (in the back of the body 12) to rotate, with which rotation the waste toner is sent into a process pipe 76 as an example of a toner passage which is at the further near side. That is, the other end of the toner conveyor screw 74 is provided in the process pipe 76, and the waste toner having undergone the toner conveyor screw 74 is sent from an exit 78 of the process pipe 76 to the waste toner box 72.

In Example 1, a moth-eye structure 82, as illustrated in FIG. 3, is provided on an inner wall surface 80a of a portion which does not have the toner conveyor screw 74 (a portion at the near side of the multifunction peripheral body 12; hereinafter, referred to as an “end” for convenience) 80 in the process pipe 76.

Since the end 80 does not have the toner conveyor screw 74, the end 80 does not have a sufficient force to move the waste toner toward the exit 78, and thus there has been a case where the waste toner remains at the end 80 and smooth transport of the waste toner to the waste toner box 72 is sometimes hindered. However, in Example 1, the waste toner is prevented from remaining by providing the moth-eye structure 82 on the inner wall surface 80a of the end 80 of the process pipe 76 to solve such a problem.

The moth-eye structure 82, as indicated by the name, means a structure shaped in the likeness of a moth's eye. For example, as shown in FIG. 3, continuous minute protrusions 84 with a minute pitch are arranged in a planar configuration. In such a moth-eye structure 82, a pitch P of the protrusions 84 is preferably set to a suitable value, for example, about 300 nm, which is a value much smaller than an average particle size of toner before a developing step (virgin toner), for example, from about 4 μm to about 14 μm, such that toner 88 is supported only by the apex of a protrusion 84, i.e., point contact, as shown in FIG. 4, and adherence of the toner to the inner wall surface of the process pipe 76 is reduced, such that the toner is prevented or inhibited from sticking to the inner wall surface of the process pipe 76. Thus, the waste toner is prevented from remaining at the end 80 of the process pipe 76, which does not have the toner conveyor screw 74, and the waste toner is smoothly be transported to the waste toner box.

Incidentally, such a moth-eye structure 82 is preferably formed by using a die including asperities configured to impart (shape) a minute asperity pattern as is disclosed in JP 2003-215314 A, paragraph [0057] and thereafter, for example. Then, the pattern is preferably directly molded on the inner wall surface of the end 80 of the process pipe 76, for example, by thermal pressing as is described in paragraph [0065] of JP 2003-215314 A. Alternatively, a “moth-eye sheet” may be prepared by pre-shaping minute asperities on a resin sheet using a die and then applying the resin sheet over a base sheet (base material), and the resulting moth-eye sheet may be applied to the inner wall surface 80a of the end 80 of the process pipe 76, as is described in paragraph [0066] of JP 2003-215314 A.

However, experiments conducted by the present inventors using Experiments 1 to 7 have revealed the following.

The pitch P of the protrusions 84 was set to the range from about 50 nm to about 400 nm. When the pitch is less than about 50 nm, micro fabrication at the time of manufacture is difficult, thus resulting in increase in defective products, and when the pitch exceeds about 400 nm, the density of the protrusion becomes too rough, thus lowering the effect of preventing or inhibiting toner from sticking by the point contact as described above.

The inventors conducted experiments making prototypes of moth-eye structures having different pitches. The inventors were unable to make a prototype with the small pitch P=less than about 50 nm despite efforts to do so.

On the other hand, when the large pitch P=up to about 300 nm, a good property was obtained with little developer having stuck to an inner wall surface. However, when the pitch P=more than about 400 nm, it was observed the effect of inhibiting developer from sticking was lowered, but the prototype was still usable. In contrast, when the pitch P=600 nm or more, the amount of developer having stuck increased, the desired property was not exhibited, and the prototype was not usable. Factors for this can be considered as follows.

That is, in the case of the toner having a typical average particle size in the order of about 5 mm to about 7 μm, some volume of fine powder is inevitably left even after undergoing a (manufacture) step of removing the fine powder. A specific particle size distribution usually includes several percentages of powder having a particle size of about 0.5 μm to about 1 μm. When the pitch P=500 nm (=0.5 μm) or more, it is considered that such fine powder was entrapped in depressions (valleys 36).

The results of the experiments conducted by the inventors are shown in Table 1 below.

TABLE 1

| | | Results (X: Failed, Δ: Not Good, |
|---|---|---|
| | P (nm) | ◯: Usable, ⊙: Excellent) |
| | <50 | Unable to make a prototype |
| Experiment 1 | 50 | ⊙ |
| Experiment 2 | 100 | ⊙ |
| Experiment 3 | 200 | ⊙ |
| Experiment 4 | 300 | ⊙ |
| Experiment 5 | 400 | ◯ |
| Experiment 6 | 500 | Δ |
| Experiment 7 | 600 | X |

Incidentally, the height D of the protrusion 84 (or the depth of a valley 86) was set to about 100 nm or more. If the height D is less than about 100 nm, fine powder of toner, e.g., functional fine particles (e.g., about 6 nm to about 7 nm) in terms of charging, flowability, and the like, which have stuck to the surface of toner, deposit in the portion of the valleys 86, thus lowering the effect of preventing or inhibiting toner from sticking by the point contact as described above.

In addition, an aspect ratio (depth D/pitch P) was set from “1” to “5.” When the aspect ratio exceeds “5,” the apex of the protrusion is subject to break because it is too sharply pointed, and when the aspect ratio is less than “1,” area to come into contact with toner becomes large, thus lowering the effect of preventing or inhibiting toner from sticking by the point contact as described above.

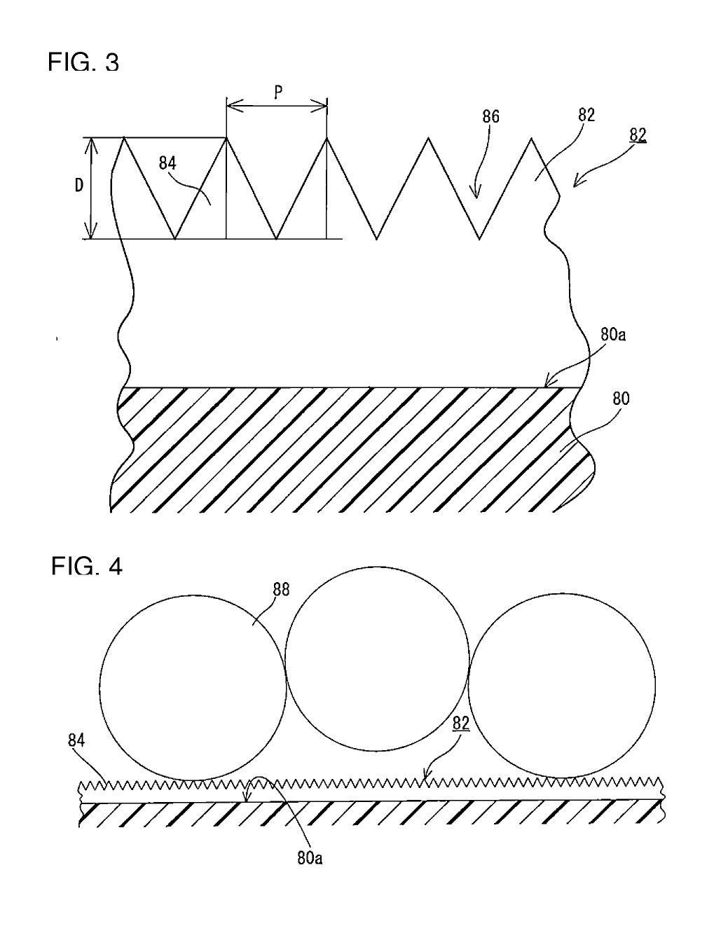

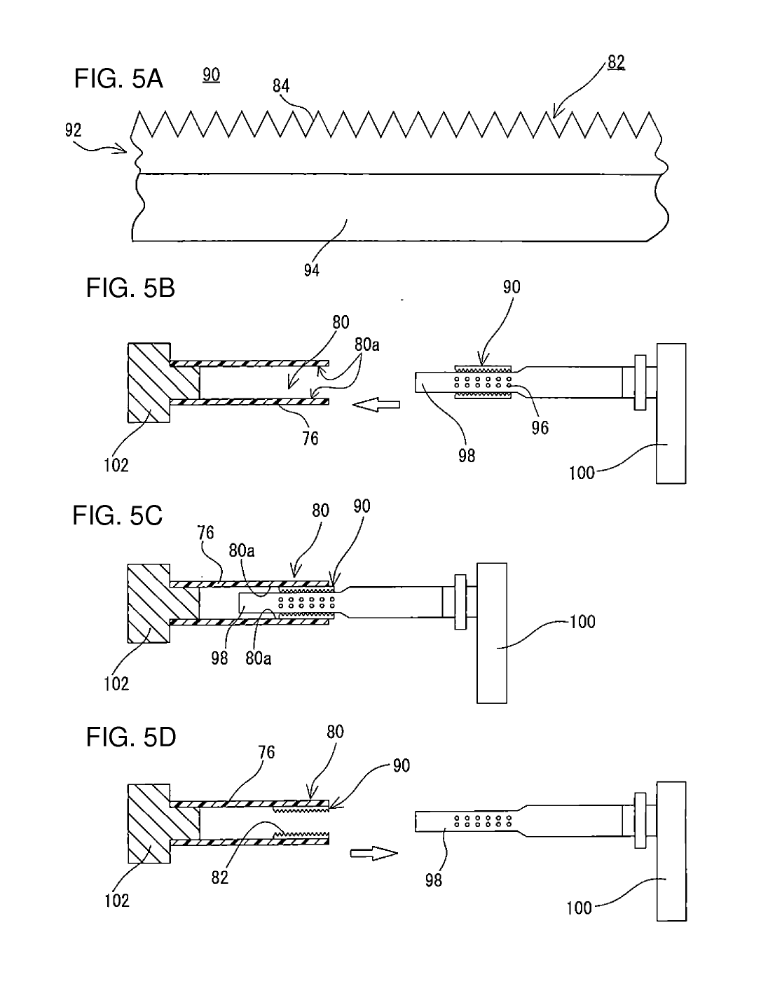

In another Example, a method shown in FIGS. 5A to 5D was used as a method for providing the moth-eye structure 82 on the inner wall surface of the end 80 of the process pipe 76, which does not have a screw.

First, a moth-eye sheet 90 as shown in FIG. 5A is prepared. The moth-eye sheet 90 preferably includes a resin sheet 92 made of a suitable resin such as urethane acrylate and having the moth-eye structure 82 as described above provided on one principal plane thereof; and a base sheet 94 having the resin sheet 92 applied to one principal plane thereof by a suitable method such as bonding or fusing.

Then, such a moth-eye sheet 90 is positioned on a shaft 98 provided with air pores 96 by a positioning member 100 so that the moth-eye structure 82 is adjacent to the shaft and, as shown in FIG. 5B, the moth-eye sheet 90 is held on the shaft 98 by air suction. Incidentally, due to the moth-eye structure 82, the air suction force applied to the surface of the moth-eye sheet 90 contacting the shaft 98 is weaker than that to a plain flat surface. Nevertheless, the moth-eye structure is sufficiently held on the shaft 98 by air suction because of its minute structure as described above.

Then, the shaft 98 holding the moth-eye sheet 90 thereon is moved by using the positioning member 100 in the direction shown by an arrow (FIG. 5B) of the process pipe 76 retained by a retainer 102, and the shaft 98 is inserted into the process pipe 76 retained by the retainer 102, as shown in FIG. 5C.

Then, the moth-eye sheet 90 is freed from the shaft 98 by a halt of the air suction through the air pores 96 of the shaft 98 or by discharging air through the air pores 96 in addition to the halt of the air suction. Following this, the moth-eye sheet 90, with its own restoring force, comes into tight contact with the inner wall surface 80a of the end 80 of the process pipe 76, which does not have the toner conveyor screw 74. At that time, an adhesive is applied to the other principal plane (the principal plane on which the moth-eye structure 82 is not provided) of the moth-eye sheet 90, such that the moth-eye sheet 90 is bonded onto the inner wall surface 80a of the end 80.

Subsequently, as shown in FIG. 5D, the shaft 98 without the moth-eye sheet is moved by using the positioning member 100 in the direction shown by an arrow away from the process pipe 76, and the shaft 98 is withdrawn from the process pipe 76. Thus, the moth-eye sheet 90 remains on the inner wall surface of the end 80 of the process pipe 76 and, as shown in FIG. 2, the moth-eye structure 82 is provided on the inner wall surface 80a of the end 80.

Incidentally, it is understood that the components and elements in the drawings including FIGS. 5A to 5D are not to scale relative to each other. For example, because FIGS. 5A to 5D are diagrammatic views, the components and elements shown have thicknesses greater than actual for the purpose of explicit demonstration of the moth-eye sheet 90.

### Example 2

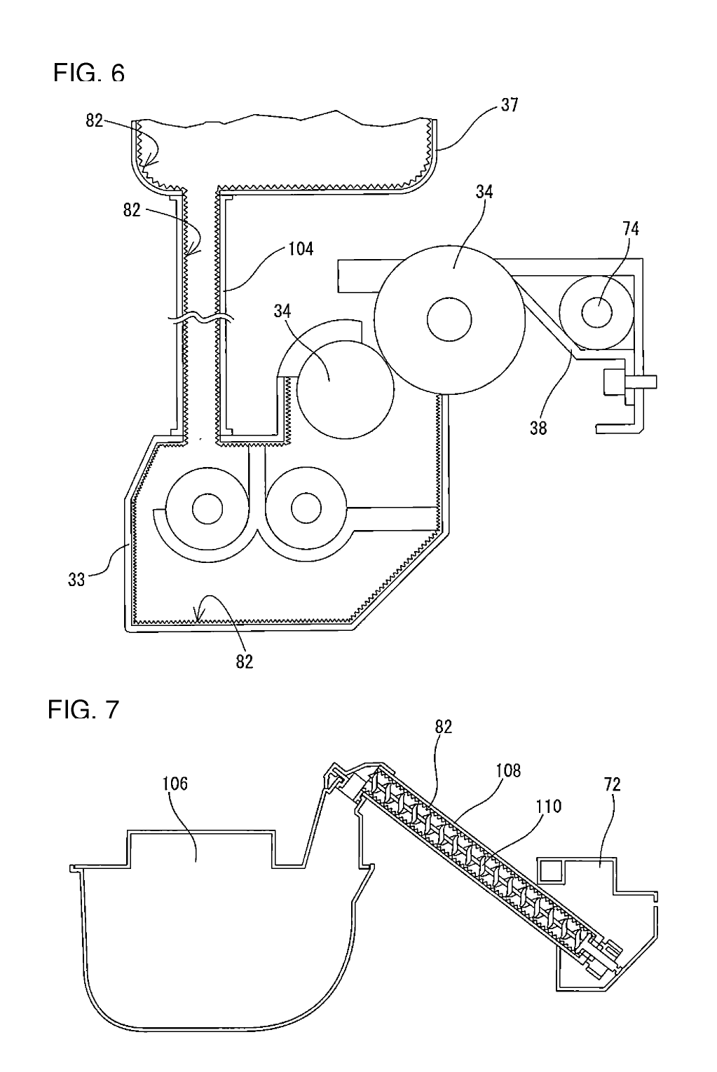

Example 2 is shown in FIG. 6. As described above with reference to FIG. 1, toner is supplied from a toner cartridge 37 to a housing 33 of a developing roller 34 via a relay pipe 104 (FIG. 6) that is an example of a toner passage. Then, in Example 2 shown in FIG. 6, a moth-eye structure 82, as illustrated in FIG. 3, is provided on an inner wall surface of the relay pipe 104.

When the toner is supplied from the toner cartridge 37 through the relay pipe 104 to the housing 33 of a developer, there has been a case where the toner is not carried smoothly despite that the flowability is not poor like waste toner and that the toner is not carried from bottom to top against gravity. The reason for this is that the toner sticks to an inner wall of the relay pipe. The surface of toner is charged due to an additive (functional fine particles) and is highly electrostatic. This is why it still sticks despite having a good flowability and even though it is not waste toner. In some techniques in the related art, for example, the relay pipe inner wall is rocked in order to solve this problem.

In contrast, in Example 2, the moth-eye structure 82 is provided on the inner surface of the relay pipe 104. Then, the moth-eye structure 82 prevents or inhibits the toner supplied from the toner cartridge 37 from sticking to the inner wall surface of the relay pipe 104, thus solving such a problem that the toner is not carried smoothly in the relay pipe 104.

In Example 2, the moth-eye structure 82 can be provided on the inner wall surface of the relay pipe 104 using the same method as described above to provide the moth-eye structure 82 on the inner wall surface of the process pipe 76. The redundant description is omitted here.

### Example 3

In Example 3, a moth-eye structure 82 is further provided on an inner wall surface of a housing 33, as shown in FIG. 6.

### Example 4

In addition, in Example 4, as shown also in FIG. 6, a moth-eye structure 82 is also provided on an inner wall surface of a toner cartridge 37.

As described above, a moth-eye structure is provided on an inner wall surface of a toner passage through which toner is carried or passes (regardless of pre- or post-developing step), to prevent or inhibit the toner from sticking to the inner wall surface of the toner passage, and thus the toner is prevented from remaining in the toner passage.

In contrast, the moth-eye structure 82 provided on the inner wall surfaces of a container and housing configured to store toner and developer, such as the toner cartridge 37 in Example 4 and the developer housing 33 in Example 3, also prevents or inhibits the toner and the developer from sticking to the inner wall surfaces of those storages, and thus the amounts of the toner and the developer remaining in the toner cartridge 37 and the developer housing 33 are significantly reduced or minimized. Thus, unused toner and developer are not disposed of, but are used efficiently.

Incidentally, as a method for providing the moth-eye structure 82 on the inner wall surface of the housing 33 and the inner wall surface of the toner cartridge 37, the pattern can be directly formed using a die; however, a method for applying the moth-eye sheet 90 as shown in FIG. 5A to these inner wall surfaces is preferable.

### Example 5

In Example 5 shown in FIG. 7, a moth-eye structure 82 is provided on an inner wall surface of a toner carrying pipe 108 configured to carry waste toner from a waste toner box 72 as shown in FIG. 2 to a toner retrieving box 106 that is provided at a back end of a multifunction peripheral 10, for example. A conveyor screw 110 preferably is provided in the toner carrying pipe 108. however, it is not easy to convey waste toner against gravity (from bottom to top) in this manner. Particularly, the waste toner (which has not been transferred and has a low electrostatic property) typically also includes paper powder, making it more difficult to convey the waste toner from bottom to top. In some techniques in the related art, a fluororesin such as glaco (a glass coating agent or a water repellent) is applied to the inner wall surface of the toner carrying pipe 108 in order to solve the problem.

In contrast, in Example 5, the moth-eye structure 82 provided on the inner wall surface of the toner carrying pipe 108 facilitates conveyance of the waste toner. The function and effect of the moth-eye structure 82 in Example 5 is also to smooth and facilitate conveyance of the waste toner by preventing or inhibiting the waste toner from sticking to the inner surface of the carrying pipe 108, which is basically the same as those in Example 1 and Example 2, and the description is not repeated here.

In accordance with Example 5, conveyance of the waste toner is smoothed and facilitated, and hence, the screw 110 to be provided in the toner carrying pipe 108 may be replaced by one with a simpler configuration.

In Example 5, the moth-eye structure is preferably provided on the inner wall surface of the toner carrying pipe 108 in the same method as described above in each of Examples for providing the moth-eye structure 82 on the inner wall surface. Therefore, the redundant description is omitted.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A storage configured to store toner or developer, comprising:
a moth-eye structure provided on an inner wall surface thereof.

2. The storage according to claim 1, wherein the moth-eye structure includes a moth-eye sheet.

3. A toner passage through which toner is carried or passes, comprising:
a moth-eye structure provided on an inner wall surface thereof.

4. The toner passage according to claim 3, wherein the moth-eye structure includes a moth-eye sheet.

5. An image forming apparatus comprising the storage according to claim 1.

6. An image forming apparatus comprising the toner passage according to claim 3.

7. An image forming apparatus comprising:
a cleaner configured to convey waste toner removed from a photoreceptor drum by a conveyor screw;
a process pipe configured to convey the waste toner transported from the cleaner to a waste toner box; and
a moth-eye structure provided on an inner wall surface of the process pipe.

8. The image forming apparatus according to claim 7, comprising:
a toner carrying pipe configured to carry the waste toner from the waste toner box to a toner retrieving box; and
a moth-eye structure provided on an inner wall surface of the toner carrying pipe.

9. An image forming apparatus comprising:
a developing roller configured to develop a latent image carried on a photoreceptor drum with developer;
a housing configured to contain the developer and supply the developer to the developing roller;
a toner cartridge configured to store toner;
a relay pipe configured to send the toner from the toner cartridge to the housing; and
a moth-eye structure provided on an inner wall surface of the relay pipe.

10. The image forming apparatus according to claim 9, further comprising a moth-eye structure provided on an inner wall surface of the housing.

11. The image forming apparatus according to claim 8, further comprising a moth-eye structure provided on an inner wall surface of the toner cartridge.

12. The image forming apparatus according to claim 5, wherein the moth-eye structure is a planar configuration including continuous minute protrusions separated by a minute pitch.

13. The image forming apparatus according to claim 12, wherein the minute pitch is about 50 nm to about 400 nm.

14. The image forming apparatus according to claim 13, wherein the minute pitch is about 50 nm to about 300 nm.
